(19) United States
(12) Patent Application Publication
(10) Pub. No.: US 2021/0175062 A1
(43) Pub. Date: Jun. 10, 2021

(54) SAMPLE PREPARATION FOR MALDI-TOF

(71) Applicant: Analytik Jena AG, Jena (DE)

(72) Inventors: Jochen Eckardt, Blankenhain OT Drößnitz (DE); Adrian Siemers, Jena (DE); Uwe Weigelt, Milda (DE)

(21) Appl. No.: 17/113,755

(22) Filed: Dec. 7, 2020

(30) Foreign Application Priority Data
Dec. 6, 2019 (DE) 10 2019 133 403.9

(51) Int. Cl. H01J 49/04

(52) U.S. Cl. CPC H01J 49/0418

(57) ABSTRACT

The present disclosure relates to a device for preparing, in an automated manner, at least one sample for analysis by means of matrix-assisted laser desorption ionization in combination with a mass spectrometric analysis, and to a corresponding method. The device comprises a sample-receiving area which is surrounded by a housing and forms an internal volume which is closed off from the surroundings, a loading/unloading device for introducing the sample into the sample-receiving area and for removing the sample from the sample-receiving area, a heating unit configured to heat at least the sample-receiving area, and a vacuum device configured to generate a vacuum in the sample-receiving area.

### CROSS-REFERENCE TO RELATED APPLICATION

The present application is related to and claims the priority benefit of German Patent Application No. 10 2019 133 403.9, filed on Dec. 6, 2019, the entire contents of which are incorporated herein by reference.

### TECHNICAL FIELD

The present disclosure relates to a device for preparing at least one sample for chemical analysis by means of matrix-assisted laser desorption ionization (MALDI) in combination with a mass spectrometric analysis, such as a time-of-flight analysis (MALDI-TOF).

### BACKGROUND

The analysis and/or characterization of samples by means of mass spectrometry is nowadays widely used in a wide variety of fields, such as in chemistry, for example, medicinal chemistry. Numerous different types of mass spectrometers have become known from the prior art, such as sector field, quadrupole, or time-of-flight mass spectrometers or also mass spectrometers with inductively-coupled plasma. The modes of operation of the various mass spectrometers have been described in numerous publications and are therefore not explained in detail here.

In a mass spectrometer, the respective molecules or atoms to be examined are first converted into the gas phase and ionized. Various methods known per se from the prior art are available for ionization, such as impact ionization, electron impact ionization, chemical ionization, photo-ionization, field ionization, the so-called fast atom bombardment, the matrix-assisted laser desorption ionization, or electrospray ionization.

After ionization, the ions pass through an analyzer, also referred to as a mass selector, in which they are separated according to their mass-to-charge ratio (m/z). A multiplicity of different variants is also available in the case of the analyzers. The different modes of operation are based, for example, upon the application of static or dynamic electric and/or magnetic fields or upon different flight times of different ions.

Lastly, the ions separated by means of the analyzer are detected in a detector. In this respect, photomultipliers, secondary electron multipliers, Faraday catchers, Daly detectors, microchannel plates, or also channeltrons have become known from the prior art, for example.

For ionization by means of MALDI, the sample material to be analyzed—frequently also referred to as analyte—is stored on a sample carrier in a matrix layer. The sample material embedded in the matrix material and affixed to the sample carrier is hereinafter referred to as a sample. The completely prepared sample is irradiated by means of a laser beam, for example, a laser pulse. As a result, part of the sample material or the molecules contained therein are ionized. These ions can subsequently be analyzed by mass spectrometry.

The preparation of the samples is complex and depends upon many different influencing factors. Important parameters are given, for example, by the choice of material for the matrix or by the concentration ratio between the matrix and the sample, and many others. Different methods for preparing the samples have thus become known, such as dried droplet preparation or thin-film preparation. In dried droplet preparation, the matrix is dissolved together with the sample in a suitable solvent and subsequently dried. In thin-film preparation, the matrix is first applied to the substrate without the sample and dried. The sample is then applied to the matrix and likewise dried. Optionally, a further layer of the matrix may subsequently be applied.

In any case, however, one or more drying processes are necessary to be able to completely prepare the respective sample. This is associated with a considerable expenditure of time, especially, in the industrial environment where great numbers of samples are to be examined. In addition, fresh sample preparation immediately before ionization and mass spectrometric analysis of the respective sample is necessary in many cases due to the material of the matrix.

DE19618032 C2 discloses a method by means of which a pre-preparation of samples is made possible. In this case, two different matrix substances, a binder, and an ionizer are used. However, this limits the field of application to corresponding matrix substances.

### SUMMARY

The present disclosure is based upon the aim of providing a possibility of being able to produce many samples automatically.

This aim is achieved by the device according to the present disclosure and the method according to the present disclosure.

With regard to the device, the aim underlying the present disclosure is achieved by means of a device for preparing, including in an automated manner, at least one sample for analysis by means of MALDI in combination with a mass spectrometric analysis, including a time-of-flight analysis. The device comprises a sample-receiving area which is surrounded by a housing and which forms an internal volume closed off from the surroundings, a loading/unloading device for introducing the sample into the sample-receiving area and for removing the sample from the sample-receiving area, a heating unit designed to heat at least the sample-receiving area, and a vacuum device designed to generate a vacuum in the sample-receiving area.

The device is, for example, used for drying the sample components, i.e., the matrix material and the sample material. In doing so, a wide variety of preparation processes, such as the dried droplet preparation or the thin-film preparation described above, can be used. Depending upon the type of preparation method, one or more drying processes are required, which can all be carried out with the device according to the present disclosure. It is thus the case that in each case the sample comprising the sample material, the matrix material, and the sample carrier is dried in the device according to the present disclosure, or parts of the sample, e.g., in a first drying process, the matrix material applied to the sample carrier, in a second drying process, the sample material introduced into the matrix material applied to the sample carrier, and, optionally, in a third drying process, the entire sample including another applied matrix layer. The number of drying processes is, accordingly, adapted to the respective preparation process.

Advantageously, the respective drying process takes place, on the one hand, in vacuo and, on the other, at a temperature of the sample that is elevated in comparison to the room temperature. This measure makes it possible to reliably complete a drying process in a defined time interval, i.e., to carry out suitable sequencing. The dependence of the time required for drying samples upon the evaporation energy emitted by the respective sample is compensated for according to the present disclosure by the additional heating.

Advantageously, however, the sample is, however, not heated directly. Rather, the sample-receiving area is heated such that the sample in the sample-receiving area is also heated. In this connection, it should be noted that drying in vacuo for accelerating the drying process is known. However, the present disclosure now combines vacuum drying with additional sample heating by heating the sample-receiving area. On the one hand, this indirect heating further accelerates the drying process. On the other, it is ensured that the sample material is not destroyed by the tempering process. Biological samples, especially, are frequently very temperature-sensitive.

In one embodiment, the heating unit is at least partially attached to the housing or introduced into the housing, wherein the heating unit is designed to heat the sample-receiving area by means of the housing. The heating unit is therefore a chamber heater which heats the housing. Consequently, the sample-receiving area and thus the sample are also tempered via the housing.

In another embodiment, the device has a temperature sensor designed to determine the temperature of the housing, of the sample-receiving area, or of the sample. In this way, the heating process can be regulated, controlled, and/or monitored. In particular, this makes it possible to ensure that a maximum permissible temperature for the sample is not exceeded. The temperature sensor can be arranged, on the one hand, in the region of the housing. In this case, it is assigned to the heating unit and serves to determine the temperature of the housing. However, the temperature sensor can also protrude at least partially into the sample-receiving area and detect the temperature within the sample-receiving area, including in the immediate vicinity of the sample. Numerous other possibilities for positioning the temperature sensor are, however, also conceivable and fall under the present disclosure.

In one embodiment, the device also has a pressure sensor designed to determine a pressure in the sample-receiving area. In this way, the vacuum generated in each case in the sample-receiving area can be regulated, controlled, and/or monitored. The pressure sensor may be part of the vacuum device. However, it can also be introduced into the housing or attached to the housing. Numerous embodiments are thus also conceivable with regard to the arrangement of the pressure sensor, and all fall under the present disclosure.

In one embodiment of the device, the loading/unloading device is designed to introduce the sample from outside into the sample-receiving area and to remove it from the sample-receiving area. The loading/unloading device may comprise mechanical means by which the sample can be conveyed from outside the sample-receiving area into the sample-receiving area and which can be driven, for example, by means of a motor. In this connection, all variants familiar to the person skilled in the art for conveying samples into an internal volume within a device housing are conceivable and fall under the present disclosure.

In another embodiment, the device has a cover which seals off the sample-receiving area from the surroundings while the sample is located in the sample-receiving area. The cover can also be designed such that it can be opened and closed manually or by means of a motor or pneumatic drive. A movement of the cover can also be coupled to a movement of the loading/unloading device.

In yet another embodiment, the device is designed to remove the sample, after a predeterminable time interval in vacuo, in an automated manner from the sample-receiving area by means of the loading/unloading device. The predeterminable time interval can be suit selected based upon one or more influencing factors. Examples of influences upon the duration of a drying process are the respective quantity of the sample material and/or matrix material, or also the thermal properties of the materials.

Lastly, in another variant, the device is designed to introduce the sample into the sample-receiving area in an automated manner after positioning in the loading/unloading device.

It is also advantageous if the device is designed to remove the sample in an automated manner from the sample-receiving area by means of the loading/unloading device after a predeterminable time interval in the sample-receiving area.

According to the present disclosure, a drying process of a sample for a matrix-assisted, laser desorption ionization can take place in an automated manner. The sample need only be introduced into the loading/unloading device. From there, it can be introduced into the sample-receiving area, dried there, and subsequently removed again from the sample-receiving area in an automated manner.

The aim underlying the present disclosure is, furthermore, achieved by a method for preparing, for example, in an automated manner, at least one sample for analysis by means of MALDI in combination with a mass spectrometric analysis, comprising the following method steps:
heating a sample-receiving area surrounding the sample by heating, and
generating a vacuum in the sample-receiving area during a predeterminable time interval.

In one embodiment of the method, a predeterminable pressure is generated in the sample-receiving area.

In another embodiment of the method, the sample-receiving area is heated to a predeterminable temperature, or the sample-receiving area is heated with a predeterminable heating power.

The heating of the sample serves to introduce thermal energy, which is lost as a result of the evaporation of solvent during the respective drying process, back into the system composed of the sample and a receiving device, e.g., a sample plate and a carrier frame. A thermal loss due to evaporation is therefore at least partially compensated for, in order to be able to guarantee complete drying under vacuum conditions.

Another embodiment of the method includes the predeterminable temperature being selected as a function of the sample, for example, as a function of a sample material, a matrix material, or a sample quantity and/or matrix quantity, and/or of the predeterminable pressure.

Yet another embodiment includes the time interval being selected as a function of the sample, for example, as a function of the sample material, of the matrix material, or the sample quantity and/or matrix quantity, of the predeterminable pressure, and/or the predeterminable temperature.

The respective drying process can thus be adapted in a targeted manner to the respectively used sample material and/or matrix material and/or to the quantity of the material used in each case. In addition, the method can be used universally for a wide variety of sample preparation methods.

It is also advantageous if the time interval is determined as a function of a time curve of the pressure in the sample-receiving area.

In this respect, it is advantageous if an end time point of the time interval is selected such that a change in the pressure over time falls below a predeterminable limit value at the end time point, for example, that the pressure be substantially constant as a function of the time at the end time point.

It is thus also possible to determine the length of the time interval on the basis of the pressure as a function of the time. In this way, it can be ensured that the time interval for drying is as short as possible, but that complete drying of the respective sample components or of the respective samples is ensured at the same time.

The embodiments described in connection with the device according to the present disclosure can also be applied mutatis mutandis to the method according to the present disclosure, and vice versa.

### BRIEF DESCRIPTION OF THE DRAWINGS

The present disclosure is described in greater detail with reference to the following figures. These show:

FIG. 1 shows an exemplary embodiment of a device according to the present disclosure; and

FIG. 2 shows an illustration of the effect of heating the sample-receiving area.

### DETAILED DESCRIPTION

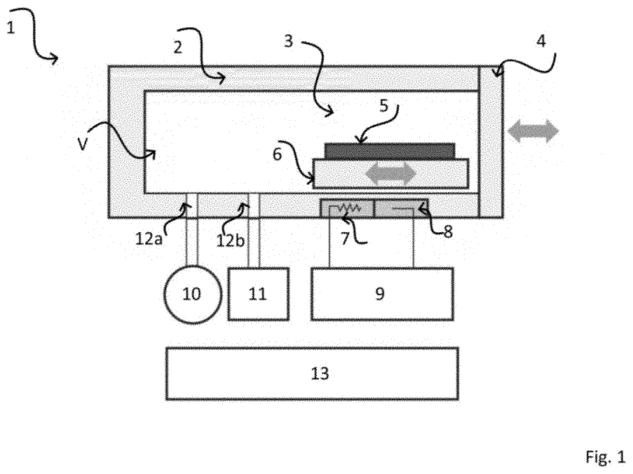

FIG. 1 shows an exemplary embodiment of the device 1 according to the present disclosure. The housing 2 forms an internal volume V which is closed off from the surroundings and which defines the sample-receiving area 3. On the right side, the housing 2 is closed by the cover 4 which is movable in the lateral direction. The sample 5 is arranged on a loading/unloading device 6. By means of the loading/unloading device 6, the sample can be moved from outside the housing 2 into the sample-receiving area 3 and out of the sample-receiving area 3. In the illustration shown here, these processes are achieved by a lateral movement of the loading/unloading device 6. Both the movements of the cover 4 and those of the loading/unloading device 6 can take place in an automated manner. For example, the movements of the cover 4 and of the loading/unloading device 6 can be coupled to one another. It is important that the cover 4 fixedly close off the sample-receiving area 3 together with the housing 2 from the surroundings of the device 1 while the sample 5 is located in the sample-receiving area 3.

Furthermore, a heating unit 7 and a temperature sensor 8 are arranged within the housing 2. The heating unit 7 is regulated by means of a heating control unit 9 on the basis of the temperature determined by the temperature sensor 8. For example, heating can take place such that the temperature in the sample-receiving area 3 is constant. If tempering takes place with a constant heating power, however, a heating control unit 9 is not absolutely necessary. In this case as well, a fixedly-installed temperature sensor 8 can be dispensed with.

The device also has a vacuum device 10 in the form of a vacuum pump, which is connected via a first passage 12a in the housing 2 to the internal volume V of the housing, and thus to the sample-receiving area 3. A vacuum in the region of the sample-receiving area 3 can be generated by means of the vacuum device 10. The device 1 also has a pressure sensor 11 which is likewise connected by a further passage 12b to the internal volume V of the housing, and thus to the sample-receiving area 3. The pressure sensor 11 serves to display the respective pressure in the sample-receiving area 3. The use of a pressure sensor 11, also, is optional in the context of the present disclosure.

It should be noted that numerous other embodiments are conceivable for a device 1 according to the present disclosure and likewise fall under the present disclosure. For example, the heating unit 7 can, at other positions, be attached to or introduced into the housing 2. Instead of being positioned in the region of the heating unit 7, the temperature sensor 8, also, can be arranged in the region of the sample 5 or can protrude into the sample-receiving area 3. In addition, numerous other embodiments and arrangements are conceivable for a loading/unloading device 6 and a corresponding cover 5, and likewise fall under the present disclosure. The cover 4 can, for example, also be arranged only through a partial region of a side wall of the housing 2 or in an upper wall of the housing 2. The cover 4 and the loading/unloading device 6 may be designed to match one another so that the sample 5 can be introduced into and removed from the sample-receiving area 3 via the cover.

The device 1 can, furthermore, optionally have a computing unit 13. The respective drying process within the sample-receiving area 3 can be controlled by means of such a computing unit 13. For example, a time interval (Δt) for the drying process can be determined on the basis of the pressure as a function of the time.

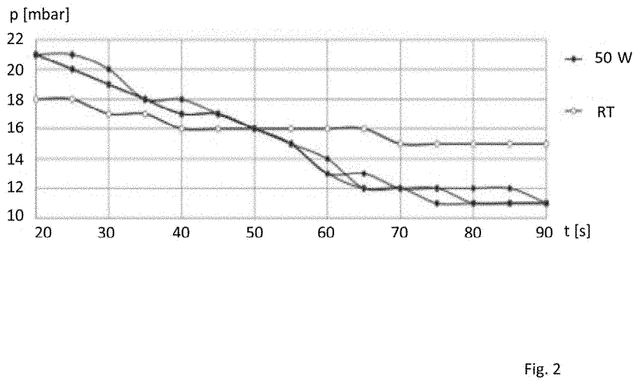

FIG. 2 shows in each case the pressure (p) in the sample-receiving area 3 as a function of the time (t) for the case of a non-heated sample-receiving area 3 (empty circles) and for the case of a sample-receiving area 3 heated with a constant heating power of 50 W (solid circles). It is clear that the heating of the sample 5 by heating the sample-receiving area 3 by means of the heating unit 7 integrated into the housing 2 leads to improved drying. The pressure in the sample-receiving area 3 is a measure of the degree of drying. At the beginning of drying a sample 5 in vacuo, the pressure rises due to the evaporation of, for example, solvent. A change in the pressure over time that remains substantially constant or remains below a predeterminable limit value indicates complete drying of the sample 5. The pressure can thus be used to determine an end time point (t_{end}) for the time interval (Δt).

Claimed is:

1. A device for preparing a sample for analysis by matrix-assisted laser desorption ionization in combination with a mass spectrometric analysis, the device comprising:
a sample-receiving area surrounded by a housing and defining an internal volume closed off from the surroundings;
a loading/unloading device configured to enable introducing the sample into the sample-receiving area and removing the sample from the sample-receiving area;
a heating unit configured to heat at least the sample-receiving area; and
a vacuum device configured to generate a vacuum in the sample-receiving area.

2. The device of claim 1, wherein the heating unit is attached to the housing or introduced into the housing, and wherein the heating unit id configured to heat the sample-receiving area via the housing.

3. The device of claim 1, further comprising a temperature sensor configured to determine a temperature of the housing, the sample-receiving area or the sample.

4. The device of claim 1, further comprising a pressure sensor configured to determine a pressure in the sample-receiving area.

5. The device of claim 1, wherein the loading/unloading device is configured to convey the sample from outside into the sample-receiving area and to convey the sample from the sample-receiving area.

6. The device of claim 1, further comprising a cover configured to seal the sample-receiving area from the surroundings when the sample is disposed in the sample-receiving area.

7. The device of claim 1, wherein the device is configured to introduce the sample into the sample-receiving area in an automated manner after positioning in the loading/unloading device.

8. The device of claim 1, wherein the device is configured to remove the sample in an automated manner from the sample-receiving area using the loading/unloading device after a predetermined time interval in the sample-receiving area.

9. A method for preparing in an automated manner a sample for analysis by matrix-assisted laser desorption ionization in combination with a mass spectrometric analysis, the method comprising:
providing a device comprising:
a sample-receiving area surrounded by a housing and defining an internal volume closed off from the surroundings;
a loading/unloading device configured to enable introducing the sample into the sample-receiving area and removing the sample from the sample-receiving area;
a heating unit configured to heat at least the sample-receiving area; and
a vacuum device configured to generate a vacuum in the sample-receiving area;
introducing the sample into the sample-receiving area;
during a predetermined time interval, heating the sample-receiving area surrounding the sample with the heating unit; and
during the time interval, generating a vacuum in the sample-receiving area.

10. The method of claim 9, further comprising generating a predetermined pressure in the sample-receiving area.

11. The method of claim 9, wherein the sample-receiving area is heated to a predetermined temperature, or wherein the sample-receiving area is heated with a predetermined heating power of the heating unit.

12. The method of claim 11, wherein the predetermined temperature is selected as a function of one or more of the sample, a material of the sample, a material of a matrix in which the sample is embedded, a quantity of the sample, a quantity of the matrix and a predetermined pressure in the sample-receiving area.

13. The method of claim 11, wherein the time interval is selected as a function of one or more of the sample, a material of the sample, a material of a matrix in which the sample is embedded, a quantity of the sample, a quantity of the matrix, a predetermined pressure in the sample-receiving area and the predetermined temperature.

14. The method of claim 9, wherein the time interval is selected as a function of a time curve of a pressure in the sample-receiving area.

15. The method of claim 14, wherein an end time point of the time interval is selected such that a change in the pressure over time falls below a predetermined limit value at the end time point.

16. The method of claim 14, wherein an end time point of the time interval is selected such that the pressure is substantially constant as a function of the time at the end time point.
